(19) United States
(12) Patent Application Publication
(10) Pub. No.: US 2003/0027597 A1
(43) Pub. Date: Feb. 6, 2003

(54) Use of over-the-air optical link within a geographically distributed base station

(76) Inventors: James T. LaGrotta, Boonton, NJ (US); Richard Thomas LaGrotta, Livingston, NJ (US)

Correspondence Address: Docket Administrator (Room 3J-219), Lucent Technologies Inc., 101 Crawfords Corner Road, Holmdel, NJ, 07733-3030, US

(21) Appl. No.: 09/919,020

(22) Filed: Jul. 31, 2001

(51) Int. Cl. H04M 1/00

(52) U.S. Cl. 455/561; 455/25

(57) ABSTRACT

A method and apparatus for reducing the cost of an RF base station that services a location where real estate is expensive without reducing the capacity of the system, subjecting the system to significant environmental interference, or purchasing additional licensed frequency spectrum. In accordance with the present invention, communication between two sections of an RF base station of a wireless communication system is implemented using an over-the-air optical link, also referred to as a wireless optical link. In particular, wireless RF communication equipment of either, or both, 1) the RF antenna and RF hardware, and 2) the processing and/or control section of the RF base station is coupled to over-the-air optical communication equipment. Overall, the present invention allows an RF base station to service the location where real estate is expensive at a much lower cost without reducing the capacity or the signal quality of the system.

### BACKGROUND OF THE INVENTION

This invention relates to wireless communication systems.

Currently, radio frequency (RF) base stations of wireless communication systems are arranged to have the RF section, which includes the RF antenna and RF hardware, and the processing and/or control section (hereinafter “processing/control section”) of the RF base station at the same location. For example, the RF antenna can be located on the roof of a building and the RF hardware and the processing/control section located in the basement of the building; or the RF antenna can be located at the top of a pole and the rest of the base station equipment located next to the pole in a sheltered enclosure.

One of the largest costs associated with the installation of an RF base station is the purchasing or renting of the real estate to locate the RF base station hardware. This is particularly true in geographic locations where real estate is expensive, such as the heart of a large metropolitan area. In such areas, it may be beneficial to locate just the portion of the base station equipment needed for good RF reception and transmission, for example the RF antenna and RF hardware, at the expensive location and the rest of the base station equipment, i.e. the processing/control section, at a less expensive location and then to connect the two sections, typically via a cable.

A problem with distributing the base station as just described is that it may be difficult and/or expensive to provide the cable connection between the two sections of the RF base station. In order to connect the two sections by cable, the cable must be run from one location to the other. Such a cable would most likely need to be run under ground. In metropolitan areas this may mean that, in some cases, conduit space may have to be rented, at significant expense. In other cases, easements may have to be obtained, again at significant expensive. And, in worst case scenarios, streets may have to be dug up before the cable is laid and patched up afterwards.

### SUMMARY OF THE INVENTION

One possible way to avoid the expense and difficulty of using cable would be to connect the two sections of the RF base station through a wireless RF connection that would operate in the same frequency band as the one used for communication between the RF base station and the terminals (e.g. mobile or fixed telephones, computers, etc.). A problem with such a wireless RF connection is that since it would operate in the frequency band used for wireless communication with terminals, it would reduce the frequencies available to the RF base station to use in communicating with terminals. This would disadvantageously reduce the capacity of the system.

Another possibility would be to connect the two sections of the RF base station through a microwave connection. However, a problem with a microwave connection is that it would expose the system to significant environmental interference from rain and fog, which reduces the signal quality. Furthermore, a microwave connection would require licensed frequency spectrum to be purchased for its operation.

The present invention is directed to solving the above problems. The present invention is advantageously less expensive then laying cable through city streets. It does not reduce the capacity of the system. It is not subject to significant environmental interference. It, currently, does not require licensed frequency spectrum to be purchased for its operation. Overall, the present invention allows an RF base station to service a location where real estate is expensive at a much lower cost without reducing the capacity or the signal quality of the system.

In accordance with the present invention, communication between two sections of an RF base station of a wireless communication system is implemented using an over-the-air optical link. In particular, wireless RF communication equipment of either, or both, 1) the RF section, which includes the RF antenna and optionally RF hardware, and 2) the processing and/or control section of the RF base station is coupled to over-the-air optical communication equipment, also referred to as wireless optical communication equipment. Over-the-air optical communication equipment is optical communication equipment adapted to provide over-the-air optical communication.

Although over-the-air optical communication equipment has been used for so-called last mile transmission in wireless communication systems, it remained for the applicants to realize that it is advantageous to couple the two disparate technologies of a) RF communication equipment and b) over-the-air optical communication equipment in the specific context of a geographically distributed base station. Significant in this regard is the fact that additional equipment would be needed to process the RF signal into optical signal and visa versa, therefore, increasing the cost of coupling two such types of equipment. It remained for the applicants to realize that the disadvantages of the additional equipment to process the signal so that it can be used with the optical and the RF equipment are outweighed in this particular context by the virtue of reduction in cost realized by not having to lay cable to connect non-co-located sections of an RF base station. Moreover, each of these types of communication equipment is capable of operating independently to communicate information between two endpoints. Thus, without the motivation provided by the applicant, there is no incentive to combine these two types of equipment, since each can be used without the other for communication between two endpoints.

### BRIEF DESCRIPTION OF THE DRAWINGS

FIG. 1 illustrates a portion of an RF base station of a wireless communication system where two sections of the RF base station are connected by a cable;

FIG. 2 illustrates a portion of a wireless communication system where two sections of an RF base station communicate with each other over an over-the-air optical link in accordance with the present invention;

FIG. 3 illustrates in more detail an equipment module of the RF base station of FIG. 2, the equipment module coupling an RF antenna and an over-the-air optical transceiver;

FIG. 4 illustrates in more detail another equipment module of the RF base station of FIG. 2, this equipment module coupling a processing and/or control section and an over-the-air optical transceiver; and

FIG. 5 illustrates a portion of a wireless communication system in accordance with another embodiment of the present invention where an RF base station includes multiple RF antennas that communicate with a processing and/or control section over over-the-air optical links.

The figures are not drawn to scale and illustrate the interconnectivity of the depicted systems and not necessarily their spatial layout and physical dimensions.

### DETAILED DESCRIPTION

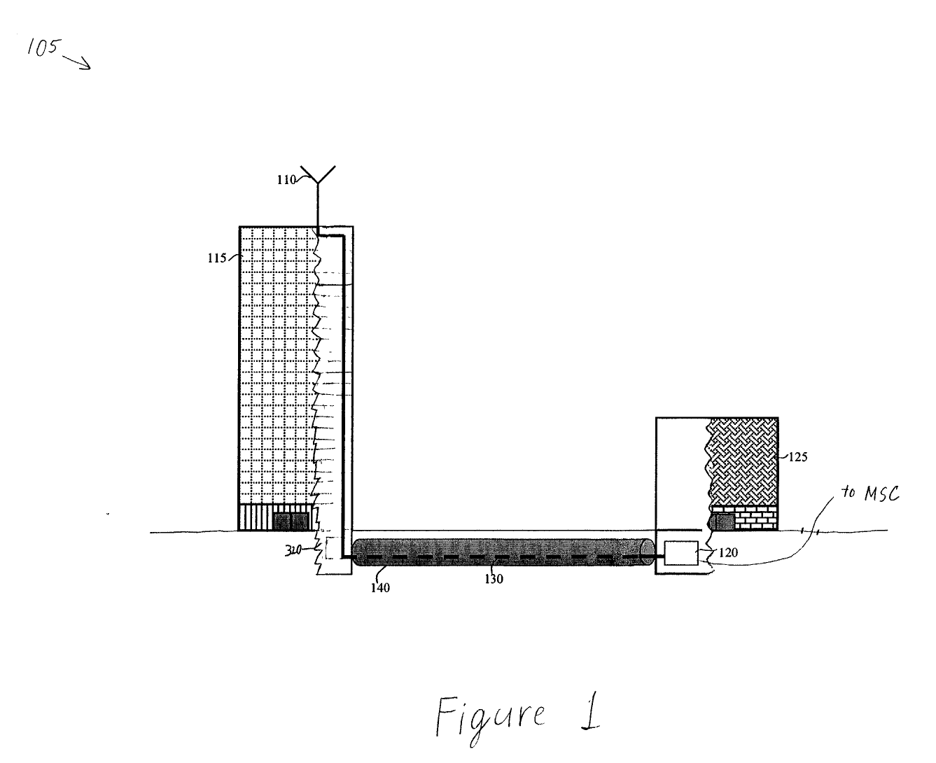

FIG. 1 illustrates a portion of RF base station 105 of a wireless communication system. RF base station 105 includes an RF section that comprises RF antenna 110 and optionally related RF hardware, such as RF-module 320, which is connected to RF antenna 110. The RF section is located at the top of building 115 which is at an expensive location, such as the heart of the downtown or cultural center of a metropolitan area. RF base station 105 also includes processing/control section 120, which is located at a less expensive location, such as the basement of building 125 on the outskirts of the metropolitan area. Processing/control section 120 connects RF base station 105 to a mobile switching center (MSC) (not shown), which is connected to local and/or long-distance transmission network, such as a public switched telephone network.

RF antenna 110 receives RF signals from terminals. RF-module 320 amplifies and filters the RF signals received on RF-antenna 110 and then converts these RF signals into digital signals. The digital signals are sent to processing/control section 120, which processes these digital signals and sends them to the MSC.

Similarly, processing/control section 120 receives digital signals from the MSC, processes these digital signals, and sends them to the RF section. In the RF section RF-module 320 converts the digital signals received from processing/control signal into RF signals, amplifies and filters these RF signals, and sends the result to RF antenna 110 for transmission. RF antenna 110 then transmits these RF signals to terminals.

The two sections of RF base station 105, i.e. the RF section and processing/control section 120, are connected by cable 130. Cable 130 runs from RF-module 320 through conduit 140, and through building 125 (also shown partially in section), to processing/control section 120. Cable 130 may also connect RF antenna 110 and RF-module 320, in which case cable 130 also runs through building 115 (shown partially in section) to RF-module 320. As described above, it may be difficult and/or expensive to provide such a cable connection from the RF section to the processing/control section.

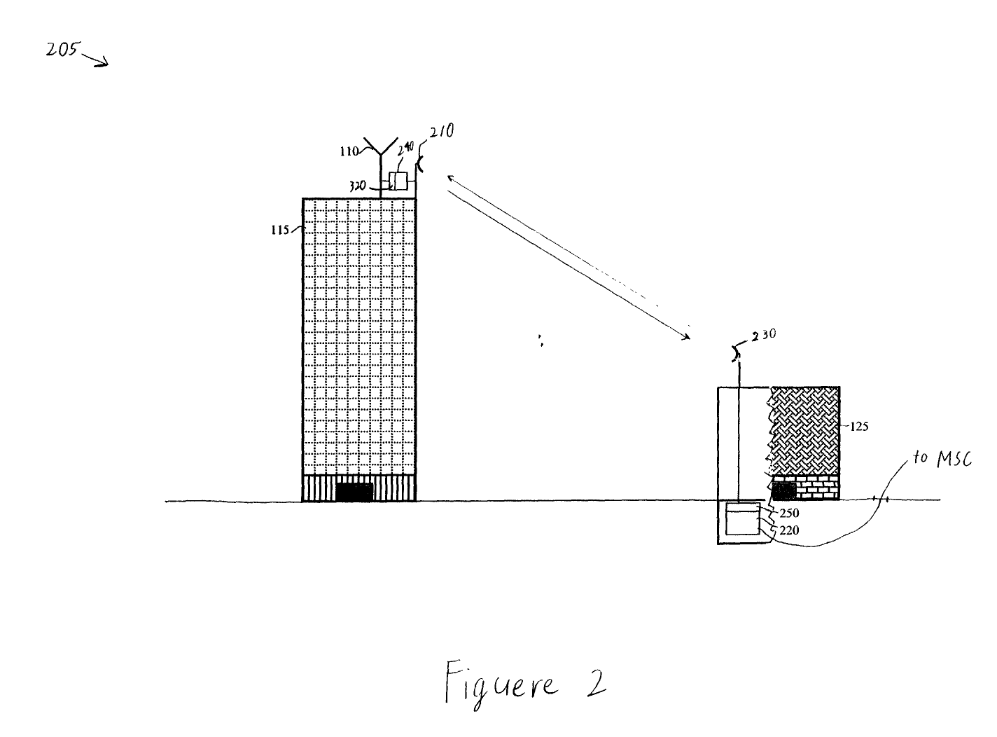

FIG. 2 illustrates a portion of RF base station 205 where, in accordance with the present invention, the two sections of RF base station 205 communicate with each other over an over-the-air optical link, also referred to as a wireless optical link. RF base station 205 includes RF wireless communication equipment, particularly, an RF section, which includes RF antenna 110 and RF-module 320, and processing and/or control section (hereinafter “processing/control section”) 220. RF base station 205 also includes wireless optical communication equipment, such as optical antennas 210 and 230, one optical antenna located near each of the sections, and equipment modules 240 and 250 to connect optical antennas 210 and 230 to RF antenna 110 and processing/control section 220, respectively. As can be seen in FIG. 2, equipment module 250 is incorporated into processing/control section 220, allowing equipment module 250 to possibly share components and/or protective casings with processing/control section 220. Alternatively, equipment module 250 may be separate from processing/control section 220, in which case processing/control section 220 could be identical to processing/control section 120 shown in FIG. 1. As can also be seen in FIG. 2, RF-module 320 is incorporated into equipment module 240, allowing RF-module 320 to share components and/or protective casings with the equipment module. Alternatively, RF-module 320 may separate from equipment module 240.

As shown in FIG. 2, RF antenna 110 is still located at the top of building 115. Optical antenna 210, which is typically a specific purpose telescope, such as an optical telescope, is also located at the top of building 115 and is coupled to the RF antenna 110 through equipment module 240. Equipment module 240 allows information received on RF antenna 110 to be transmitted on optical antenna 210 and visa versa. (Power for equipment module 240 can be provided through any manner, such as an AC power connection through an outlet in building 115, or a battery coupled to the equipment module).

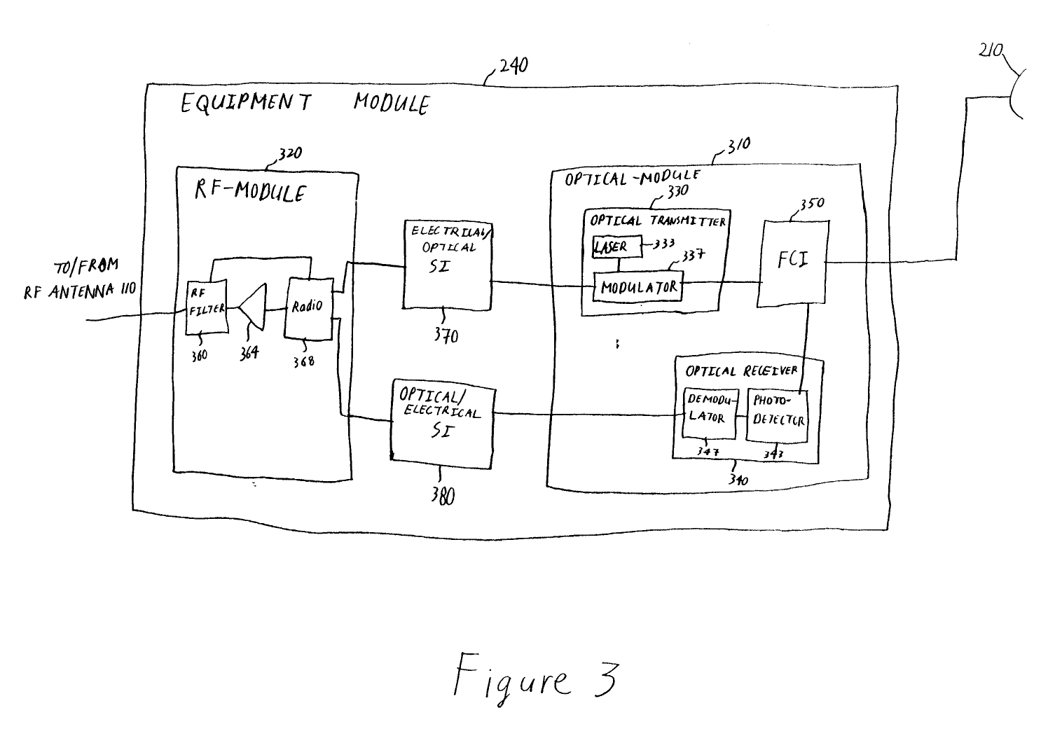

FIG. 3 shows equipment module 240 in more detail. Equipment module 240 includes optical-module 310 and RF-module 320. Optical-module 310 includes optical transmitter 330 and optical receiver 340. Optionally, both the optical transmitter 330 and optical receiver 340 are coupled to fiber-coupling interface 350, which couples optical transmitter 330 and optical receiver 340 to optical antenna 210. Optical transmitter 330 includes a laser, such as semiconductor laser 333, that generates a light beam, and modulator 337 that modulates the light beam using the signal received from RF-module 320 and electrical/optical signal interface 370, as described below. Optical transmitter 330 also includes an optical amplifier, not shown, that amplifies the resulting modulated light beam. The emitting facet of the laser (or an optical fiber to which the laser is coupled through the fiber-coupling interface) lies at the front focal plane of optical antenna 210.

Optical receiver 340 includes photodetector 343. Photodetector 343 (or an optical fiber connected to the photodetector through the fiber-coupling interface) is positioned at the focal plane of optical antenna 210. Photodetector 343 detects the received light beam and converts it into an analog electrical signal. Additionally, optical receiver 340 can also include demodulator 347 for recovering from this analog electrical signal the signal carried by the light beam. The signals recovered from the demodulator will typically be digital signals. For a more detailed discussion of wireless optical systems, see, for example, P. F. Szajowski, “Key Elements of High-Speed WDM Terrestrial Free-Space Optical Communications Systems,” SPIE Paper No. 3932-01, Photonics West (January, 2000); and International Patent Application entitled “Wireless Fiber-Coupled Telecommunication Systems Based on Atmospheric Transmission of Laser Signals”, Publication Number WO 00/04653; and U.S. patent application entitled “Point-to-Multipoint Free-Space Wireless Optical Communication System”, Ser. No. 09/679,930, all incorporated herein by this reference.

Optical-module 310 is coupled to RF-module 320. RF-module 320 includes RF filter 360, amplifier 364, and radio 368. Filter 360 filters the signals received on RF antenna 110, amplifier 364 then amplifies these signals and passes them to radio 368. Radio 368 converts these filtered and amplified RF signals into digital signals. Radio 368 also converts the digital signals recovered by demodulator 347 into RF signals. The later RF signals are then amplified in amplifier 364, filtered, and then passed to RF antenna 110.

Optionally, equipment module 240 also includes optical/electrical signal interface 380 and electrical/optical signal interface 370. Optical/electrical signal interface 380 is coupled between RF-module 320 and optical receiver 340. Electrical/optical signal interface 370 is coupled between RF-module 320 and optical transmitter 330. Optical/electrical signal interface 380 converts the signal carried by the light beam, and recovered in the optical module, into a signal that can be processed by RF-module 320. Electrical/optical signal interface 370 converts the signal processed by RF-module 320 into a signal that can be modulated onto on the light beam. In the illustrative embodiment, optical/electrical signal interface 380 decodes the signal that optical-module 310 recovers from the analog electrical signal. As described above, the analog electrical signal is obtained from the light beam. This decoded signal is typically in digital form. Optical/electrical signal interface 380 then passes the decoded signal to RF-module 320, where the decoded digital signal is converted into an RF signal, and otherwise prepared for transmission on RF antenna 110. Electrical/optical signal interface 370 encodes the digital signal provided by the RF-module. The resulting encoded digital signal is passed to optical-module 310 where it is used to modulate the light beam. As described above, the light beam is then amplified and transmitted on optical antenna 210, as shown in FIG. 2.

The processed light beam is received by optical antenna 230, which is typically similar to optical antenna 220. Optical antenna 230 is located at a less expensive location then RF antenna 110 and optical antenna 210. For example optical antenna 230 can be located at the top of building 125 on the outskirts of the metropolitan area. Optical antenna 230 is coupled to processing/control section 220 through equipment module 250. Processing/control section 220 is similarly located at the less expensive location, such as, for example, the basement of building 125. Thus, the RF section and processing/control section 220, and therefore the RF antenna 110 and processing/control section 220, are non-co-located and are a significant distance from each other. This distance may be any distance at which real estate prices differ, such as for example, any distance greater then or equal to 10 meters. Thus, in areas where real estate prices change significantly in the space of a few building it may be beneficial to separate RF antenna 110 and processing/control section 220 by 10 meters, and in other area they may be ½ mile or more apart.

Equipment module 250 allows information received at processing/control section 220 to be transmitted on optical antenna 230 and information received on optical antenna 230 to be processed by processing/control section 220. Equipment module 250 is similar to equipment module 240 except it does not include an RF-module. Thus, the optical antennas are adapted to communicated signals between the two sections of the RF base station.

In operation, when an RF signal is received from a terminal by RF antenna 110 the RF signal is passed to equipment module 240, shown in FIG. 3. Particularly, the RF signal is passed to RF-module 320 where filter 360 filters the RF signal. Amplifier 364 amplifies the filtered RF signal. Radio 368 then converts the filtered and amplified RF signal into a digital signal. The digital signal is sent to electrical/optical signal interface 370 where, as described above, the digital signal provided by radio 368 is encoded. The resulting encoded digital signal is passed to optical-module 340 where modulator 337 modulates this signal onto a light beam generated by semiconductor laser 333. The resulting processed light beam is amplified in optical amplifier and transmitted by optical antenna 210. The signals received by RF antenna 110 conform to a predefined wireless communication standard, such as for example a code division modulation, CDMA, standard such as IS-95, or a time division modulation, TDMA, standard such as IS-136. The signals communicated by optical antenna 210 represent information that conforms to the same predefined wireless communication standard.

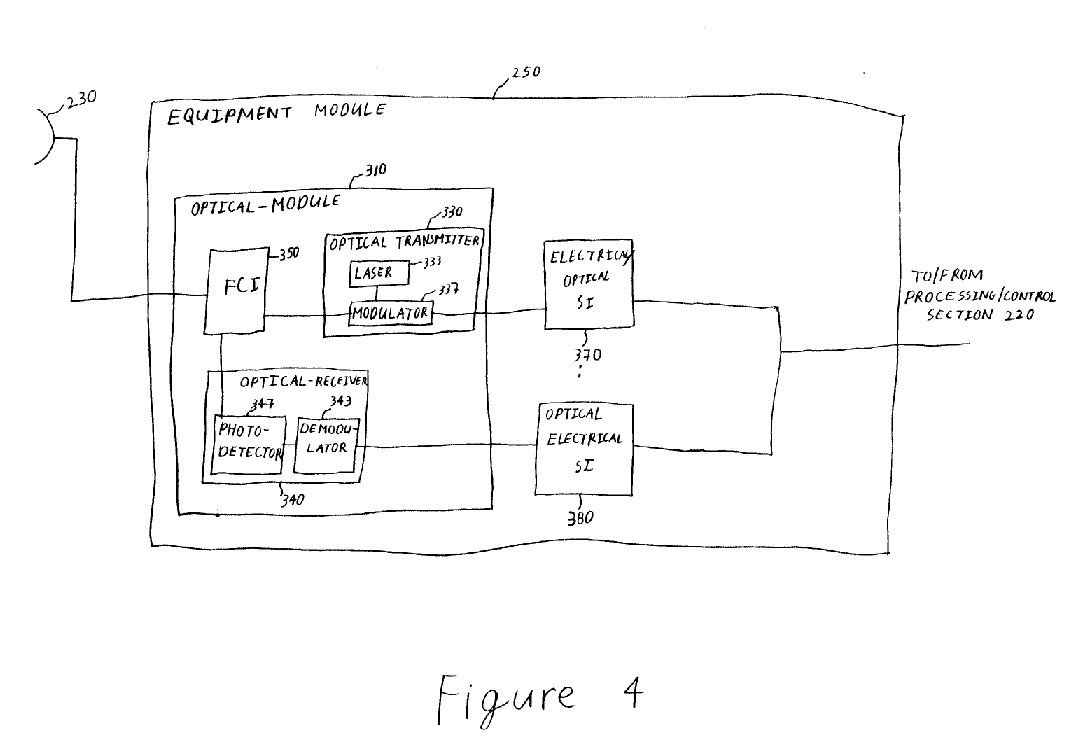

The processed light beam is received by optical antenna 230 and passed to optical receiver 340 of equipment-module 250, shown in FIG. 4, where photodetector 343 converts the received light beam into an analog electrical signal. This analog electrical signal is demodulated in demodulator 347 to recover the signal carried by light beam. Optical/electrical signal interface 380 decodes the signal recovered by demodulator 347, thus recovering the signal provided by radio 368 to electrical/optical signal interface 370. This signal is then passed to processing/control section 220.

Similarly, when a signal is received from the network through the mobile switching center by processing/control section 220, the signal is processed in the processing/control section 220. The resulting signal is then passed to equipment module 250 where the electrical/optical signal interface 370 converts this signal into a form that can be modulated onto on a light beam and passes it to optical-module 340. In optical-module 340 modulator 337 modulates this signal onto a light beam generated by semiconductor laser 333. The resulting processed light beam is amplified in optical amplifier and transmitted by optical antenna 230.

The processed light beam is received by optical antenna 210 and passed to optical receiver 340 of equipment-module 240, shown in FIG. 3, where photodetector 343 converts the received light beam into an analog electrical signal. This analog electrical signal is demodulated in demodulator 347 to recover the signal carried by light beam. Optical/electrical signal interface 380 converts the signal carried by light beam, and recovered in the optical module, into a signal that can be processed by RF-module 320. RF-module 320 then converts this signal into a form in which it can be transmitted on RF-antenna 110. This signal is then transmitted over RF-antenna 110.

Implementing communication between two sections of RF base station 205 using an over-the-air optical link is less expensive then laying cable through city streets. It does not reduce the capacity of the system. It is not subject to significant environmental interference. It, currently, does not require licensed frequency spectrum to be purchased for its operation. Overall, it allows RF base station 205 to service a location where real estate is expensive at a much lower cost without reducing the capacity or the signal quality of the system.

Furthermore, illustratively, many processing/control sections 220 can be located near each other at the outskirts of the metropolitan area. This would allow for a reduction in maintenance and upgrade cost. The RF heads could be designed with high-reliability equipment that is not subjected to frequent upgrades as new features are added to the system. On the other hand, the many circuit cards that contain software, firmware, and hardware (such as processor chips) that are being upgraded more regularly to add features or take advantage of the steady growth speeds and new software algorithms would be located in the processing/control section. Thus, in the present invention, less physical locations would typically need to be visited for upgrades or more frequent maintenance, reducing the cost in time spent traveling to each processing/control section.

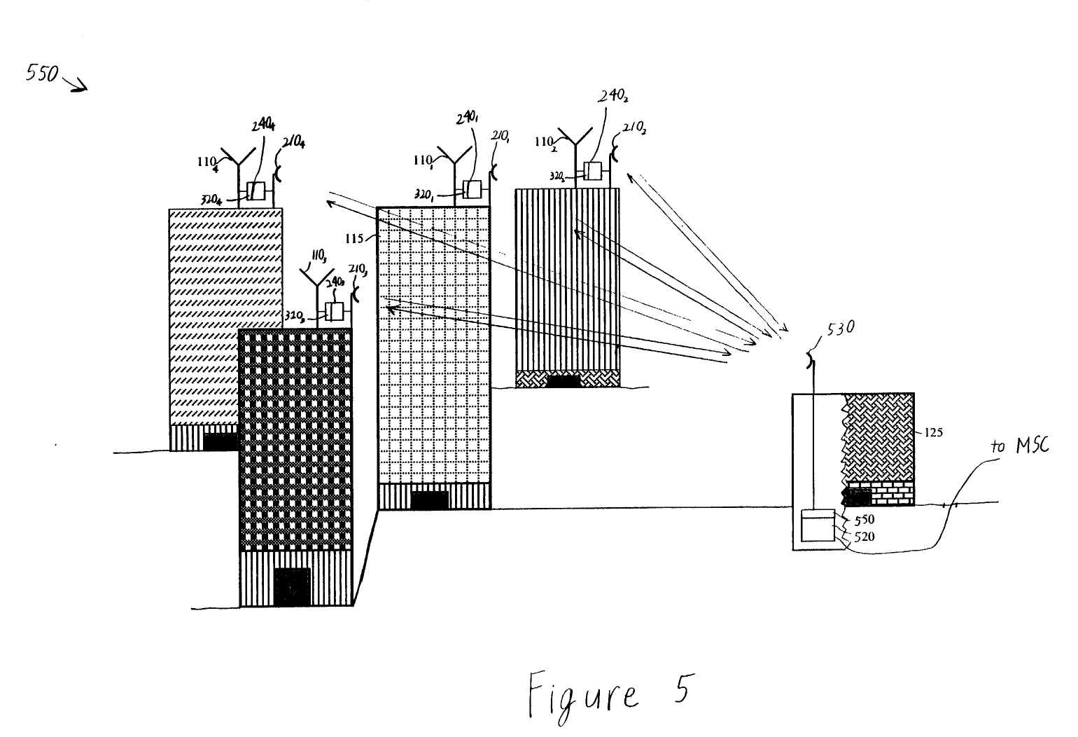

Another embodiment of present invention is shown in FIG. 5. In this embodiment RF base station 505 includes more RF section, and therefore more RF antennas, than processing/control sections. For example, in the illustrative embodiment shown in FIG. 5, one processing and/or control section (hereinafter “processing/control section”) 520 services multiple RF sections, each of which includes antennas 110₁, 110₂, 110₃, and 110₄ and RF-modules 320₁, 320₂, 320₃, and 320₄ There is an over-the-air optical link between each of the RF antennas 110₁, 110₂, 110₃, and 110₄ and processing/control section 520. Each of the RF antennas 110₁, 110₂, 110₃, and 110₄ is coupled to a respective optical antenna 210₁, 210₂, 210₃, and 210₄ through a respective equipment module 240₁, 240₂, 240₃, and 240₄. Processing/control section 520 is coupled to optical antenna 530 through equipment module 550. Optical antenna 530 communicates with the multiple optical antennas 210₁, 210₂, 210₃, and 210₄. For a more detailed description on the operation of an optical antenna adapted to communicate with multiple optical antenna see U.S. patent application entitled “Point-to-Multipoint Free-Space Wireless Optical Communication System”, Ser. No. 09/679,930. Equipment module 550 allows information received at processing/control section 520 to be transmitted on optical antenna 530 to any of the multiple RF sections and information received on optical antenna 530 from any of the multiple RF sections to be processed by processing/control section 520. Illustratively, equipment module 550 includes an optical-module, an electrical/optical signal interface and an optical/electrical signal interface for each RF section with which optical antenna 530 is designed to communicate.

In addition to the advantages discussed above, the just above described embodiment also allows for a further reduction in equipment costs. This is due to the fact that complex equipment is consolidated into a fraction of the cell sites, and shares both 1) the links back to the mobile switching center, usually T1 lines, and 2) other equipment such as the physical cabinet, power supplies, heat exchanges, fans, etc. Thus, while each processing/control section 520 would be larger, to service multiple RF antennas, the price will not scale up proportionally, and as the number of RF antennas serviced by the same process/control section increases, so does the savings potential. Moreover, by designing RF base station 550 as described above, most of the upgrades and features can be implemented at processing/control section 520 maintenance and upgrade cost can be further reduced since there are fewer processor/control sections 520 at which to perform maintenance and at which upgrades are performed.

The foregoing is merely illustrative and various alternatives will now be discussed. For example, in the illustrative embodiment the electrical/optical signal interface and the optical/electrical signal interface serve as interfaces between the wireless RF communication equipment and the wireless optical communication equipment. In alternative embodiments of the invention, if the optical transmitter is capable of modulating the signal provided by the RF module directly onto the light beam then the electrical/optical signal interface and optical/electrical signal interface may be not be need and may be left out.

In the illustrative embodiment of the invention the processing/control section is located in the basement of building 125. In alternative embodiments of the invention the processing/control section can be located at any location reasonably near its optical antenna. For example, processing/control section 220 can be located at the top of building 125 next optical antenna 230.

The block diagrams presented in the illustrative embodiments represent conceptual views of illustrative circuitry embodying the principles of the invention, one or more of the functionally of the circuitry represented by the block diagrams may be implemented in software by one skilled in the art with access to the above descriptions of such functionally.

Thus, while the invention has been described with reference to a preferred embodiment, it will be understood by those skilled in the art having reference to the specification and drawings that various modifications and alternatives are possible therein without departing from the spirit and scope of the invention.

We claim:

1. RF base station apparatus comprising:
first wireless RF communication equipment; and
wireless optical communication equipment coupled to the first wireless RF communication equipment,
the wireless optical communication equipment being adapted to communicate signals between the first wireless RF communication equipment and other equipment of the RF base station, and
the first wireless RF communication equipment and the other equipment being non-co-located.

2. The apparatus of claim 1, wherein the first wireless RF communication equipment is at a significant distance from the other equipment of the RF base station.

3. The apparatus of claim 2, wherein the significant distance is at least ten meters.

4. The apparatus of claim 1, wherein:
the first wireless RF communication equipment is adapted to receive signals that conform to a predefined wireless communication standard; and
the signals that the wireless optical communication equipment is adapted to communicate represent information that conforms to the predefined wireless communication standard.

5. The apparatus of claim 1, wherein the first wireless RF communication equipment comprises an RF antenna.

6. The apparatus of claim 5, wherein the first wireless RF communication equipment further comprises an RF-module.

7. The apparatus of claim 1, wherein the wireless optical communication equipment comprises a telescope.

8. The apparatus of claim 1, wherein the first wireless RF communication equipment comprises a processing section of the RF base station.

9. The apparatus of claim 1, wherein the first wireless RF communication equipment comprises a processing and control section of the RF base station.

10. An RF base station comprising:
an RF antenna;
first wireless optical communication equipment coupled to the RF communication equipment;
a section of equipment of the RF base station,
the section of equipment being at a significant distance from the RF antenna;
second wireless optical communication equipment coupled to the section of equipment of the RF base station; and
the first wireless optical communication equipment being adapted to communicate with the second wireless optical communication equipment.

11. The apparatus of claim 10, wherein:
the RF antenna is adapted to receive signals that conform to a predefined wireless communication standard; and
the signals that the wireless optical communication equipment is adapted to communicate represent information that conforms to the predefined wireless communication standard.

12. The RF base station of claim 10, further comprising:
at least one other RF antenna; and
at least a third wireless optical communication equipment, each being adapted to communicate with the second wireless optical communication equipment; one wireless optical communication equipment being coupled to each RF antenna.

13. The RF base station of claim 10, wherein the significant distance is at least ten meters.

14. The RF base station of claim 10, wherein the section of equipment of the RF base station comprises a processing section of the RF base station.

15. The RF base station of claim 10, wherein the section of equipment of the RF base station comprises a processing and control section of the RF base station.

16. The RF base station of claim 10, wherein:
the first wireless optical communication equipment comprises a first telescope; and
the second wireless optical communication equipment comprises a second telescope.

17. A method comprising the steps of:
receiving an RF signal at an RF antenna of an RF base station;
modulating a signal representing the RF signal onto an optical signal; and
transmitting the optical signal by wireless optical communication equipment to a section of equipment of the RF base station.

18. The method of claim 17, further comprising the steps of:
receiving the optical signal on second wireless optical communication equipment of the RF base station,
the second wireless optical communication equipment coupled to the section of equipment of the RF base station; and
obtaining the signal representing the RF signal from the optical signal.

19. The apparatus of claim 17, wherein:
signals received by the RF antenna conform to a predefined wireless communication standard; and
the signals transmitted by the wireless optical communication equipment represent information that conforms to the predefined wireless communication standard.

20. The method of claim 17, wherein the section of equipment of the RF base station comprises a processing section of the RF base station.

21. The method of claim 17, wherein the section of equipment of the RF base station comprises a processing and control section of the RF base station.

22. The method of claim 17, further comprising the step of processing the RF signal to produce a signal that can be modulated onto an optical signal, wherein this step is performed prior to the modulating step.

23. The method of claim 17, wherein the wireless optical communication equipment comprises a telescope.

24. A method comprising the steps of:
obtaining a signal at a section of equipment of the RF base station;
modulating a signal representing the signal onto an optical signal; and
transmitting the optical signal over wireless optical communication equipment to an RF antenna of the RF base station.

25. The method of claim 24, further comprising the steps of:
receiving the optical signal on second wireless optical communication equipment of the RF base station, the second wireless optical communication equipment coupled to the RF antenna; and
obtaining the signal from the optical signal;
obtaining an RF signal from the signal;
transmitting the RF signal on the RF antenna.

26. The method of claim 24, wherein the section of equipment of the RF base station comprises a processing section of the RF base station.

27. The method of claim 24, wherein the section of equipment of the RF base station comprises a processing and control section of the RF base station.

28. The method of claim 24, wherein the wireless optical communication equipment comprises a telescope.

29. RF base station apparatus comprising:
an RF antenna of the RF base station apparatus; and
a telescope coupled to the RF antenna, the telescope being adapted to communicate signals between the RF antenna and other equipment of the RF base station apparatus,
the RF antenna being at a significant distance from the other equipment of the RF base station, and wherein
signals received by the RF antenna conform to a predefined wireless communication standard, and
the signals communicated by the telescope represent information that conforms to the predefined wireless communication standard.

30. The apparatus of claim 29, wherein the significant distance is at least ten meters.
